(19) United States
(12) Patent Application Publication
(10) Pub. No.: US 2017/0017778 A1
(43) Pub. Date: Jan. 19, 2017

(54) Providing Font Security

(71) Applicant: Monotype Imaging Inc., Woburn, MA (US)

(72) Inventors: Nathan Ford, Dallas, TX (US); Soaurabh Kakkar, Delhi (IN); Hemant Sharma, Ghaziabad (IN); Mukesh Kumar, Sonepat (IN)

(21) Appl. No.: 15/211,110

(22) Filed: Jul. 15, 2016

Related U.S. Application Data
(60) Provisional application No. 62/193,974, filed on Jul. 17, 2015.

(51) Int. Cl. G06F 21/10; G06F 11/30; H04L 29/06

(52) U.S. Cl. CPC G06F 21/10; H04L 63/10; G06F 11/3096; G06F 11/3006; G06F 2221/0737

(57) ABSTRACT

A computing device implemented method includes, at a font monitor, receiving data representing one or more activities related to providing one or more fonts to the computing device from a font service provider. The method also includes identifying at least one of the one or more activities as being associated with an unauthorized activity, and, initiating action to correct the at least one activity associated with the unauthorized activity.

### CLAIM OF PRIORITY

This application claims priority under 35 USC §119(e) to U.S. Patent Application Ser. No. 62/193,974, filed Jul. 17, 2015, the entire contents of which are hereby incorporated by reference.

### BACKGROUND

This description relates to protecting font data from activities contrary to an end user agreement. By securing the font data, prohibited activities such as copying, moving, etc. temporarily licensed fonts is cutoff.

Proportional to the astronomical growth of available content, for example via the Internet, the demand to express such content has grown. In line with this expansion in content, developers, designers, publishers, etc. have grown accustomed to having a vast variety of fonts to present textual content. To select and license fonts of interest from a font provider, often perspective licensees (e.g., designers, etc.) are granted temporary access to a font for use during a trial period. Unfortunately, some view such periods as an invitation for illicit activities such as unwarranted copying of the fonts.

### SUMMARY

The systems and techniques described protect fonts, e.g., provided during temporary trial periods, subscription periods, etc., from being compromised (e.g., copied, moved, etc.) in a prohibited manner. By monitoring the local use of these fonts, corrective action can be quickly executed upon detection of improper activities. Along with halting such operations other functionality may also be provided (e.g., sending alerts, identifying wrongful actors, logging unauthorized activities, etc.) to protect the fonts. Further, such techniques can protect font distributors from violations of entered agreement with font developers and other third parties.

In one aspect, a computing device implemented method includes, at a font monitor, receiving data representing one or more activities related to providing one or more fonts to the computing device from a font service provider. The method also includes identifying at least one of the one or more activities as being associated with an unauthorized activity, and, initiating action to correct the at least one activity associated with the unauthorized activity.

Implementations may include one or more of the following features. The font monitor may operate in an independent manner at the computing device. The font monitor may be included in an application executable by the computing device. Identifying the least one of the one or more activities as being associated with an unauthorized activity may include the font monitor detecting a font file being copied. Identifying the least one of the one or more activities as being associated with an unauthorized activity may include the font monitor detecting a font file being moved. Identifying the least one of the one or more activities as being associated with an unauthorized activity may include the font monitor detecting activity being initiated by an application. Identifying the least one of the one or more activities as being associated with an unauthorized activity may include the font monitor detecting activity being initiated by a user. Identifying the least one of the one or more activities as being associated with an unauthorized activity may include the font monitor monitoring an operating system of the computing device. Identifying the least one of the one or more activities as being associated with an unauthorized activity may include the font monitor detecting the mounting or unmounting of a data storage drive. Initiating action to correct the at least one activity associated with an unauthorized activity may include deleting copied versions of a font file. Initiating action to correct the at least one activity associated with an unauthorized activity may include initiating an alert signal. Initiating action to correct the at least one activity associated with an unauthorized activity may include logging a report of a detected incident. Initiating action to correct the at least one activity associated with an unauthorized activity may include halting a usage period of one or more fonts. The font monitor may employ an application programming interface. The font monitor may be configured to monitor communications between the computing device and a font service provider.

In another aspect, a system includes a computing device that includes a memory configured to store instructions of a font monitor. The system also includes a processor to execute the instructions of the font monitor to perform operations that include receiving data representing one or more activities related to providing one or more fonts to the computing device from a font service provider. Operations also include identifying at least one of the one or more activities as being associated with an unauthorized activity. Operations also include initiating action to correct the at least one activity associated with the unauthorized activity.

Implementations may include one or more of the following features. The font monitor may operate in an independent manner at the computing device. The font monitor may be included in an application executable by the computing device. Identifying the least one of the one or more activities as being associated with an unauthorized activity may include the font monitor detecting a font file being copied. Identifying the least one of the one or more activities as being associated with an unauthorized activity may include the font monitor detecting a font file being moved. Identifying the least one of the one or more activities as being associated with an unauthorized activity may include the font monitor detecting activity being initiated by an application. Identifying the least one of the one or more activities as being associated with an unauthorized activity may include the font monitor detecting activity being initiated by a user. Identifying the least one of the one or more activities as being associated with an unauthorized activity may include the font monitor monitoring an operating system of the computing device. Identifying the least one of the one or more activities as being associated with an unauthorized activity may include the font monitor detecting the mounting or unmounting of a data storage drive. Initiating action to correct the at least one activity associated with an unauthorized activity may include deleting copied versions of a font file. Initiating action to correct the at least one activity associated with an unauthorized activity may include initiating an alert signal. Initiating action to correct the at least one activity associated with an unauthorized activity may include logging a report of a detected incident. Initiating action to correct the at least one activity associated with an unauthorized activity may include halting a usage period of one or more fonts. The font monitor may employ an application programming interface. The font monitor may be configured to monitor communications between the computing device and a font service provider.

In another aspect, one or more computer readable media storing instructions that are executable by a processing device, and upon such execution cause the processing device to perform operations that include, at a font monitor, receiving data representing one or more activities related to providing one or more fonts to the computing device from a font service provider. Operations also include identifying at least one of the one or more activities as being associated with an unauthorized activity. Operations also include initiating action to correct the at least one activity associated with the unauthorized activity.

Implementations may include one or more of the following features. The font monitor may operate in an independent manner at the computing device. The font monitor may be included in an application executable by the computing device. Identifying the least one of the one or more activities as being associated with an unauthorized activity may include the font monitor detecting a font file being copied. Identifying the least one of the one or more activities as being associated with an unauthorized activity may include the font monitor detecting a font file being moved. Identifying the least one of the one or more activities as being associated with an unauthorized activity may include the font monitor detecting activity being initiated by an application. Identifying the least one of the one or more activities as being associated with an unauthorized activity may include the font monitor detecting activity being initiated by a user. Identifying the least one of the one or more activities as being associated with an unauthorized activity may include the font monitor monitoring an operating system of the computing device. Identifying the least one of the one or more activities as being associated with an unauthorized activity may include the font monitor detecting the mounting or unmounting of a data storage drive. Initiating action to correct the at least one activity associated with an unauthorized activity may include deleting copied versions of a font file. Initiating action to correct the at least one activity associated with an unauthorized activity may include initiating an alert signal. Initiating action to correct the at least one activity associated with an unauthorized activity may include logging a report of a detected incident. Initiating action to correct the at least one activity associated with an unauthorized activity may include halting a usage period of one or more fonts. The font monitor may employ an application programming interface. The font monitor may be configured to monitor communications between the computing device and a font service provider.

These and other aspects, features, and various combinations may be expressed as methods, apparatus, systems, means for performing functions, program products, etc.

Other features and advantages will be apparent from the description and the claims.

### DESCRIPTION OF DRAWINGS

FIG. 1 illustrates a font distribution environment.

FIG. 2 illustrates fonts provided to a computing device for use during a trial, subscription, etc. period.

FIG. 3 illustrates monitoring for prohibited font-related activities and responding to these activities.

FIGS. 4, 5, 6, 6A, 6B, and 7 are flowcharts of operations for monitoring font-related activities and taking appropriate corrective action.

FIG. 8 illustrates an example of a computing device and a mobile computing device that can be used to implement the techniques described here.

### DETAILED DESCRIPTION

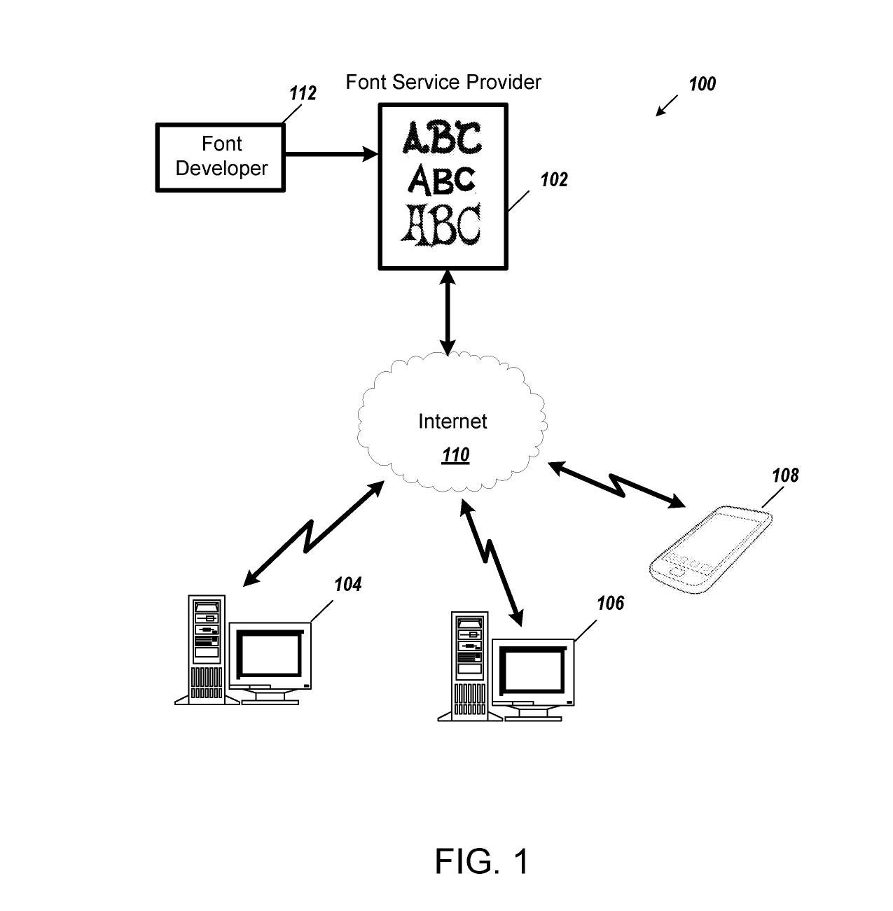

Referring to FIG. 1, an environment 100 is shown for distributing fonts to from a font service provider 102 to multiple computing devices (e.g., computer system 104 and 106, and a mobile smartphone 108). In this example, the fonts are sent via a network (e.g., the Internet 110) and one or more protocols may be employed. In a typical scenario, a user (e.g., designer) of a computing device (e.g., computer system 104) may be developing any type of asset such as an electronic document, a web asset (e.g., a web page, a web site, a web-based advertisement, etc.) etc., and interested in using one or more fonts in this development effort. By executing one or more items of software (e.g., a desktop application, a web-based application, etc.), the computing device can establish a connection with the font service provider 102 and thereby allow the user to view many candidate fonts for possible selection and use. To assist the user with making a final determination, one or more fonts can be provided to the user for use during a trial period. Typically such periods of time are predefined and relatively short (e.g., a few minutes, etc.) and the fonts are to be considered temporary (e.g., the fonts will be removed from the device after the trial period). However, given the opportunity to use such fonts during this period (or during a subscription period), a user may be tempted to copy the fonts before expiration and before entering into a contractual agreement (e.g., agree to a license for the fonts). Such activities would be considered unauthorized and could not only violate a licensing agreement with the font service provider 102 but also potentially violate an agreement between the font service provider and a developer 112 of the font that has been illegitimately acquired by the end user.

In some instances, software being used to review and investigate these temporary fonts may provide a vehicle for improperly attaining a copy of the fonts. For example, an application executed by the computer system 104 such as an publication application (for developing electronic publications), word processor and other types of applications capable of testing a candidate font (e.g., review how certain content presents in a font) can be an unwitting accomplice in the wrongful taking of the font. To address such underhanded activities one or more techniques may be employed; for example, activities of the computer system 104 may be monitored for detecting such activities and correspondingly take proper corrective action.

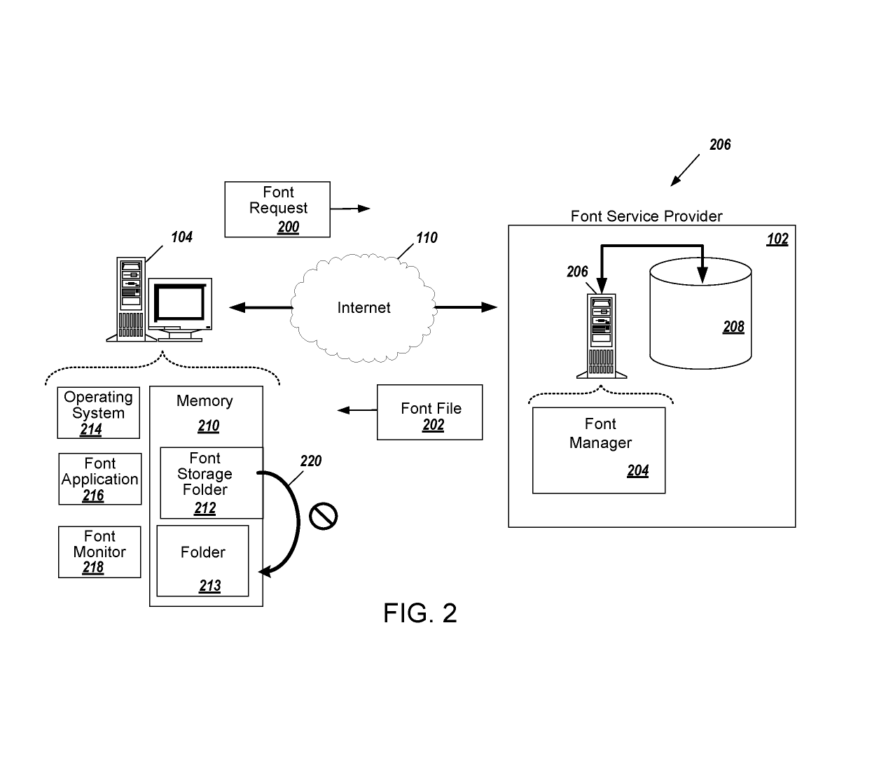

Referring to FIG. 2, components of the computer system 104 and the font service provider 102 are illustrated that assist with detecting improper font-related activities and taking corrective action. As shown in the figure, based upon a request 200 being sent to the font service provider 102 (e.g., via the Internet 110) from the computer system 104, a font file 202 is delivered to the computer system 104 from the font service provider 102. To gather the appropriate font data, a font manager 204 is executed by a server 206 located at the font service provider 102, in this example. Along with gathering the font data from sources internal (e.g., storage device 208) and/or external (e.g., remotely located storage devices, etc.) to the font service provider 102, the font manager 204 also controls, maintains, etc. the trial periods that the provided fonts can be used by the computer system. Subscription periods may also be controlled by the font manager 204. With this information determined, the font file 202 (e.g., that includes font data) is delivered to the computer system 104 from the font service provider 102.

In this example, upon receipt of the font file 202, the delivered font data (e.g., that represents the candidate fonts for use during the trial period) is stored at a particular location in memory 210 of the computer system 104. In this illustrated example, the location is labeled a font storage folder 212 that is accessible by an operating system 214 executed by the computer system 104. Also in this example, a local application 216 is executed by the computer system 104 to present potential candidate fonts, initiate the sending of the font request 200 to the font service provider 102, and assist the user with investigating the candidate fonts after being placed in the font storage folder 212. Additionally, the font application 216 may register the font(s) (provided by the received font data) at the storage location (e.g., the font storage folder 212).

To detect improper use of the fonts in the font storage folder 212 (which can be considered as temporary fonts due to the limited trial period), a font monitor 218 is also executed by the computer system 104. In the illustrated example, the font monitor 218 is separate from the font application 216; however, in some arrangements a portion or the entire functionality of the font monitor 218 may be incorporated into the font application 216. Other architectures (e.g., software, hardware, software/hardware architectures) may be implemented to provide the functionality of the font application 216 and the font monitor 218. In general, the font monitor is capable of detecting one or more prohibited activities involving the temporary fonts included in the font storage folder 212. For example, unauthorized copying, moving, etc. of one or more of the temporary fonts can be detected by the font monitor 218, along with initiating corrective action. As illustrated with graphic 220, the font monitor 218 is capable of detecting an attempt to improperly store one temporary font (or more) in a portion of the memory 210 (labeled folder 213). Such illicit operations may be initiated by a user, an application being executed by the computer system 104, a combination of user and application operations, etc. However by detecting and halting such activities, the probability of violating a license agreement (or potential license agreement) between the user and the font service provider, the font service provider and a developer of the temporary font, etc. may be significantly reduced.

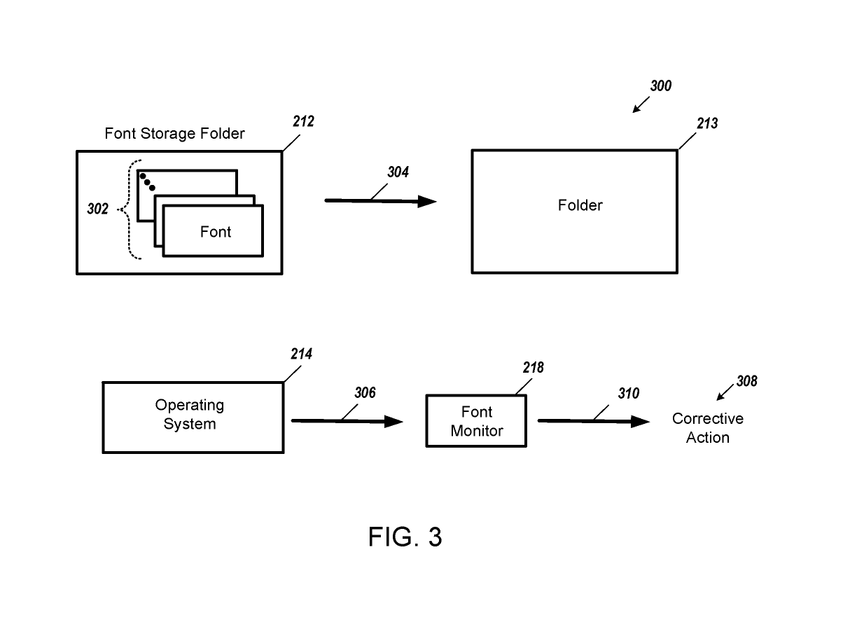

Referring to FIG. 3, a data flow 300 graphically represents techniques for detecting improper operations (represented with arrow 304) regarding one or more fonts 302 in the font storage folder 212. One such improper operation could be the moving of one or more of the fonts 302 from the font storage folder 212 to another location of the computer system (e.g., folder 213). Such improper operations may be initiated by various types of actors. For example, a user (e.g., designer) may initiate the operation. Applications or other types of software may also initiate unauthorized activities; for example, a publication application (e.g., electronic document development application) may include packaging functionality that can attempt to move, copy, etc. font data (e.g., embed font(s) within an application, file, etc.). In another scenario, modifications to a folder could be considered an improper operation involving the stored fonts (e.g., trial fonts, subscription fonts, etc.). For example, modifications to permissions, immutability, etc. of a folder (e.g., the font storage folder 212) can be considered an unauthorized operation. In general, the font monitor 218 is capable of detecting a variety of events indicative of an improper operation being attempted. For example, the font monitor 218 may monitor information (e.g., signals, data, etc.) being provided by the operating system 214 of the computer system 104. As graphically represented by arrow 306, some types of detectable events associated with improper operations include notifications of mounting, unmounting, etc., of storage devices internal to the computer system (e.g., hard drives), external to the system (e.g., pen drives (also known as flash memory sticks)), etc. Detection events may also include indications that files, folders, etc., are being created, modified, etc. In some instances, the font monitor 218 is aware of acceptable events that should not trigger corrective action. For example, file operations of the font application 216 may be identified as acceptable activities (e.g., creating or modifying files, folders, etc.). For activities deemed improper, corrective action(s) 308 may be initiated by the font monitor 218 as graphically illustrated with arrow 310.

One or more techniques may be employed by the font monitor 218 to receive information from the operating system 214 along with other possible sources. For example, application programming interfaces (API's) can be considered a set of routines, protocols, etc. that can be utilized by the font monitor 218 to get data that represents a variety of file system events. Along with the mounting, unmounting, etc. of drives; data provided by the operating system 214 to the font monitor 218 can detect if a file, folder, etc. has been created, modified, etc. in the computer system or in any attached device (e.g., external hard drive, pen drive, etc.). Typically notification of such events occurs quickly, for example, the font monitor is typically alerted in fractions of a second by the employed techniques (e.g., a call back technique). Other types of events detectable by the font monitor 218 include status indicators. For example, if the communication link between the font service provider 102 and the computer system 104 is no longer active (e.g., a user has logged out of an established connection with a service provider), action may be taken such that trial fonts, subscription fonts, etc. may be removed from the font storage folder 212. Changes to relationships may also be detected and trigger corrective action. For example, if a related account with font service provider 102 is no longer active, suspended, etc., the user may be banned from future font trial periods, subscriptions, etc. and corrective action is initiated.

Various type of corrective actions 308 may be initiated based upon the event(s) detected by the font monitor 218. For example, trial fonts, subscription fonts, etc. may be deleted from the font storage folder 212 to halt any further use of the fonts (e.g., the fonts are deleted due to the ending of a trial period, subscription period, etc.). If the copying, moving, etc. of fonts (from the font storage folder 212) has been detected, corrective action 308 may include the deleting of the copied versions of the fonts (in some cases, along with deleting the original versions of the fonts). In a similar manner, upon the detection of a file, folder, etc. being created, modified, etc. for performing an unauthorized operation with the fonts of the font storage folder 212 (e.g., create a file for storing unauthorized copies of the fonts), the font monitor 218 may initiate corrective action. For example, the file, folder, etc. may be identified and included for being monitored (by the font monitor 218). Upon detecting that font data is being moved (e.g., copy and pasted, moved, etc.) to the file, folder, etc. corrective action may be initiated (e.g., delete the copied version of the font data, delete the file, folder, etc.). So, based upon a file, folder, etc. being created, modified, moved, etc. the unauthorized new copy of can be deleted. As described below, one or more techniques may be used by the font monitor 218; for example, a call back technique may be used to take such corrective action. Other types of corrective action may also be employed, for example, one or more alerts may be provided. In one arrangement, prior to deleting an unauthorized file, folder, etc., a visual, audible, etc. alert may be presented by the computer system 104. Logging, report generation, etc. may also be considered as corrective action. For example, upon the detection of an unauthorized activity, the font monitor 218 may initiate operations to identify the party associated with the unauthorized activity (e.g., identify the user, the address of the computing device, etc.), generate a report that represents the unauthorized activity (e.g., type of activity, user identity, computing device identity, etc.), and initiate the sending of the report to one or more parties (e.g., to the font service provider 102—for example to impose a penalty, to one or more font developers, etc.). By allowing such violations to be tracked and penalties applied, the frequency of such events may decrease.

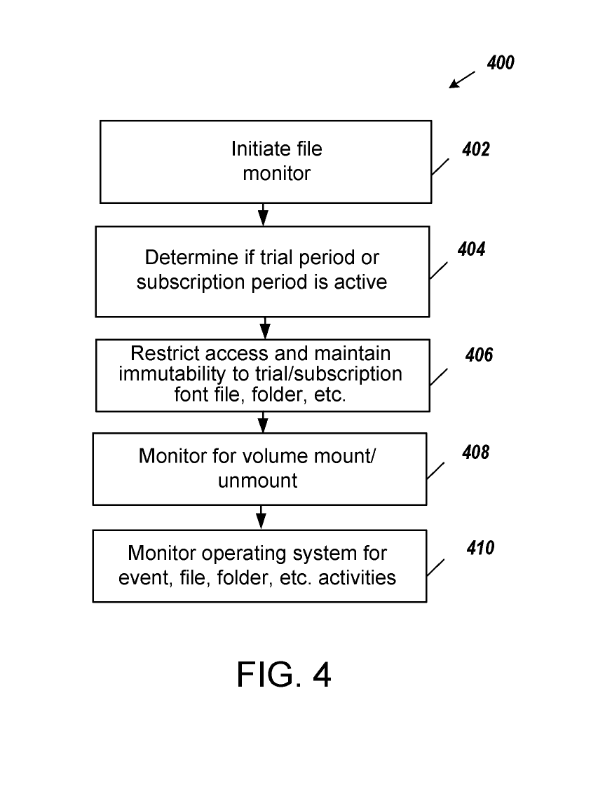

Referring to FIG. 4, a flowchart 400 represents some operations of a font monitor (e.g., the font monitor 218 shown in FIG. 2) being executed by a computing device (e.g., the computer system 104). Operations of the font monitor 218 are typically executed by a single computing device (e.g., the computer system 104); however, operations may be executed by multiple computing devices. Along with being executed at a single site (e.g., a user's location), the execution of operations may be distributed among two or more locations. In some arrangements, a portion of the operations may be executed by an application executed by the computer system (e.g., font application 216). Operations of the font monitor may also be executed at two or more locations. For example, a portion of the operations may be executed at a font service provider (e.g., by the server 206), at an intermediate computing device (e.g., located between a user device and the font service provider), with one or more computing devices, etc.

Some operations can be considered as initial operations of the font monitor. For example, operations may include initiating 402 the file monitor (e.g., font monitor 218) and determining 404 if a trial period is active or if a subscription period is active. If such a trial period or subscription period is not active, the font monitor can wait until one or more becomes active. If such a trial period or subscription period is active, operations can include providing 406 restricted access and maintain immutability of font files, font folders, etc. for trial periods, subscription periods, etc. For example, corresponding fonts stored in the font storage folder 212 may be accessible with a valid trial period or subscription period being active. Further, during such time periods changes to font files, folders, etc. is generally prohibited to maintain font integrity. Operations may also include monitoring 408 for volume mounting, unmounting, etc. For example, mounting of storage devices internal to the local computing device, external to the device, etc. may eventually be involved with illicit activities such as attempts to copy, move, etc. temporary fonts (e.g., trial fonts, subscription fonts, etc.) to a location separate from the font storage folder. To monitor volume mounting, unmounting, etc., the font monitor can receive notification (e.g., from the operating system). Once alerted, the font monitor can identify the one or more volumes, devices, etc. (associated with the mounting, unmounting, etc.) in a list of current volumes, devices, etc. to be monitored. Operations may also include monitoring 410 the operating system for event, file, folder, etc. activities. For example, the font monitor may be provided information (e.g., signals) from the operating system that indicates that a file, folder, etc. is being created, modified, etc. Monitoring may include processing received information to determine which operations may be unauthorized or allowable. For example, received information can be processed (e.g., filtered) to identify events, font files, folders, etc. associated with a link (e.g., a communication link) between the font service provider and the computer system. In some arrangements, some information from the operating system may be filtered and not acted upon. For example, file, folder, etc. operations of an application associated with providing the fonts to the computer system (e.g., font application 216) may not be considered as indicating potentially unauthorized activity.

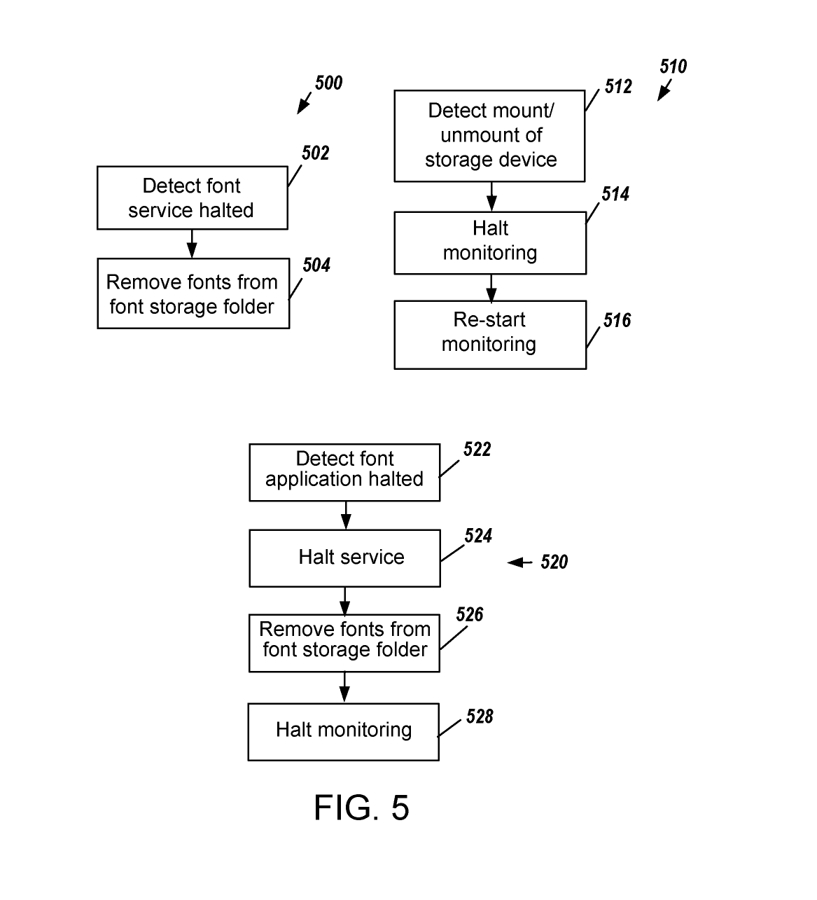

Referring to FIG. 5, a flowchart 500 represents further operations of a font monitor (e.g., the font monitor 218 shown in FIG. 2) to initiate corrective action based upon a detected event associated with unauthorized font operations. For example, upon detecting 502 that a service has halted (e.g., a user trial, subscription, etc. service has become unlinked by actions of the user, an executed application, etc.) corrective action can be initiated. Operations may include removing 504 fonts (e.g., trial fonts, subscription fonts, etc.) from the computing device (e.g., computer system 104). In some arrangements, the trial period, subscription period, etc. would be ended. Typically, monitoring is not halted upon the service being halted; however, in some arrangements monitoring may be halted (e.g., monitoring is halted when trial, subscription services are unlinked). Flowchart 510 represents other operations that may be executed by the font monitor to initiate corrective action upon detecting an event. In this example, upon detecting that a storage device(s) has been mounted, unmounted, etc., operations may include halting 514 the monitoring by the font monitor. In general, the monitoring is halted for a short period of time (e.g., a fraction of a second). While halted, a list of volumes, drives, etc. to be monitored is updated to include the newly identified storage device(s) (e.g., volume(s), drive(s), etc.) that has been mounted, unmounted, etc. Once the list is updated, operations can include re-staring 516 the monitoring of the devices. In some arrangements, updating a list of volumes, drives, etc. may be dynamically executed and monitoring can continue (rather than being halted to perform the update). Flowchart 520 represents operations that may be executed based upon detecting 522 that an application used to provide candidate fonts (e.g., the font application 216) has been halted (e.g., a user, another application, etc. has ended the execution of the application). Upon detecting the application halt, operations may include halting 524 service, for example, a logout operation can be executed to stop services (e.g., linked to, logged into, etc.). Operations may also include removing 526 one or more fonts (e.g., trial fonts, subscription fonts, etc.) from storage on the computing device (e.g., the font storage folder 212), and, halting 528 monitoring operations (of the font monitor).

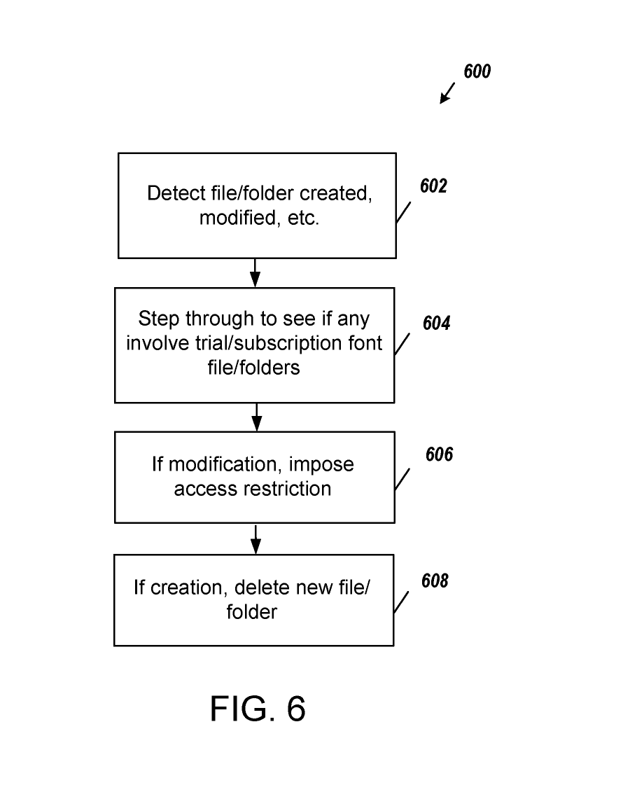

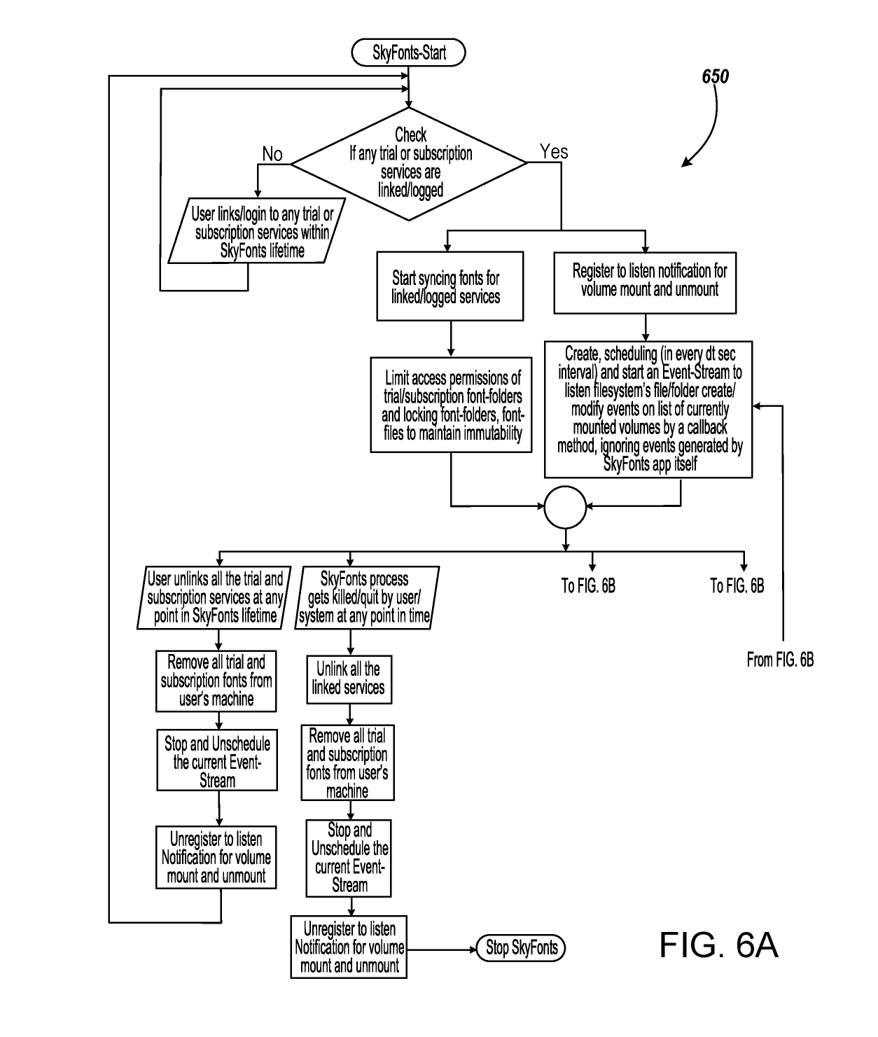

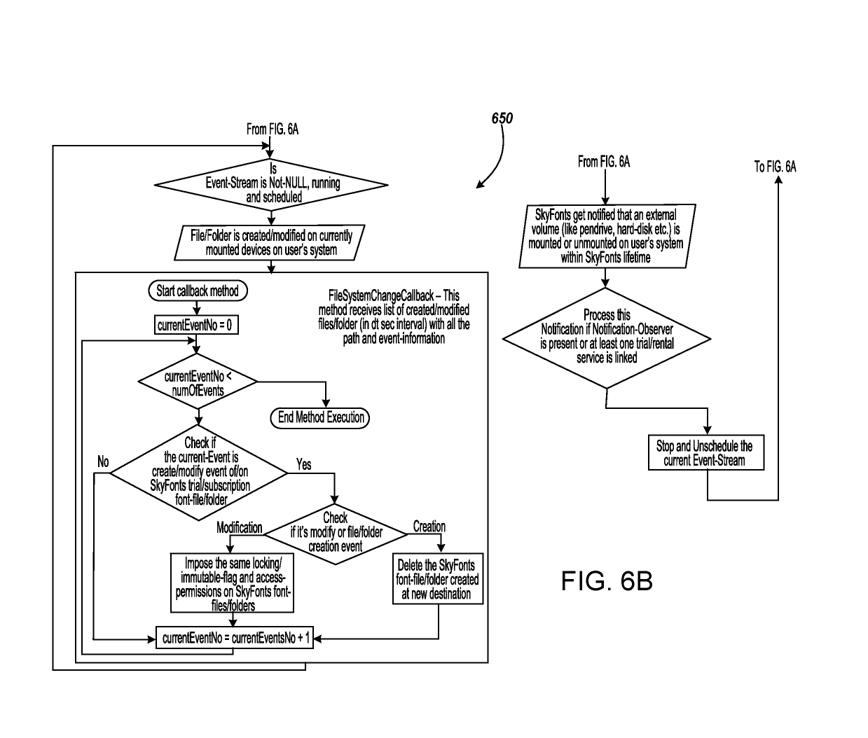

Referring to FIG. 6, a flowchart 600 represents operations of a font monitor (e.g., the font monitor 218 shown in FIG. 2) to initiate corrective action based upon a detected event in which a file, folder, etc. is being created, modified, etc. In this example, operations include detecting 602 the file/folder being created, modified, etc. (e.g., on the user computing device, on an attached external device, etc.) during a trial period, subscription period, etc. when a font application is being executed. Upon detection, operations include stepping 604 through to determine if any font file, folders, etc. associated with a font trial, subscription, etc. are involved in the creation, modification, etc. If such a font file, folder, etc. is being modified, operations may include imposing 606 access restrictions (e.g., same immutability/locking, access permission, etc.) as applied to other files, folders, etc. associated with a font trial, subscription, etc. (e.g., the font storage folder 212). If such a font file, folder, etc. is being created, operations may include deleting 608 the newly created font file, folder, etc. (e.g., at the new destination). Referring to FIGS. 6A and 6B, a flowchart 650 is illustrated that combines the functionality of the flowcharts in FIGS. 4, 5 and 6. As provided in the flowchart 650, access permissions to font folders, font files, etc. is controlled to secure the related font information. Additionally, if a process that links a user device and font service provider is halted, the services being provided by the font service provider are halted and related fonts (e.g., trial fonts, subscription fonts, etc.) are removed from the user device. The flowchart also monitors the creating, modifying, etc. of created files, folders, etc. for improper activities associated with the provided fonts.

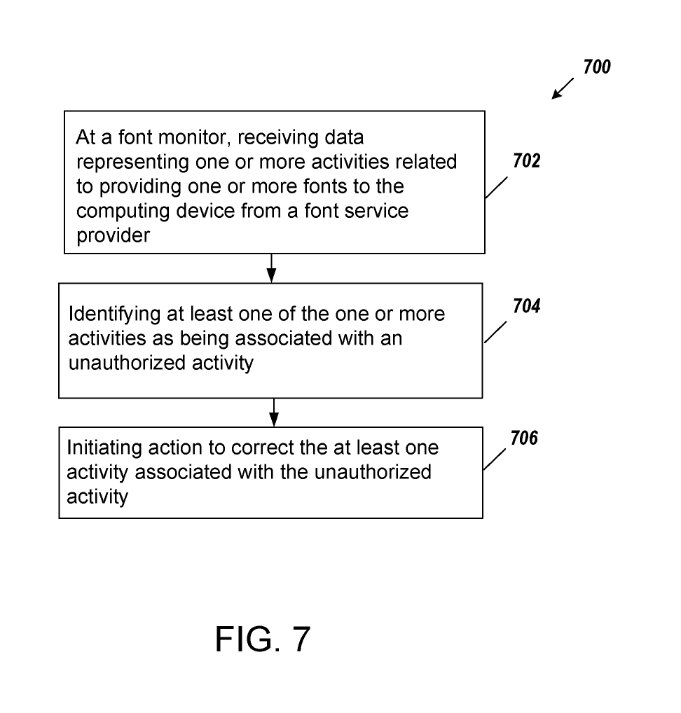

Referring to FIG. 7, a flowchart 700 represents some operations of a font monitor (e.g., the font monitor 218 shown in FIG. 2) being executed by a computing device (e.g., the computer system 104). As mentioned above, operations of the font monitor are typically executed by a single computing device (e.g., the computer system 104); however, operations may be executed by multiple computing devices. Additionally, font monitor operations may be executed at a single site (e.g., a user's location), distributed among two or more locations, etc. As also mentioned, a portion of the operations may be executed by an application that is being executed by the computer system (e.g., font application 216). Operations may also be executed at multiple locations; for example, a portion of the operations may be executed at a font service provider (e.g., by the server 206), at an intermediate computing device (e.g., located between a user device and the font service provider), at one or more computing devices, etc.

Operations may include, at a font monitor, receiving 702 data representing one or more activities related to providing one or more fonts to the computing device from a font service provider. For example, received data may represent the current status of a subscription for one or more fonts being provided by a font service provider. Received data may also be provided from other types of sources, for example, data from an operating system of a computing device may be provided to the font monitor. Operations may also include identifying 704 one of the one or more activities as being associated with an unauthorized activity. For example, data from the operating system may indicate that a font file is being moved, copied, etc. in an authorized manner. The received data may also indicate that the subscription status with a font service provider has changed (e.g., is no longer valid), for another example. Operations may also include initiating action to correct the at least one activity associated with the unauthorized activity. For example, once detected, services from a font service provider may be halted, unauthorized file operations (e.g., copying, moving, etc.) may similarly be halted and any misappropriated data (e.g., copied font files) addressed (e.g., deleted) to maintain control of fonts from the font service provider.

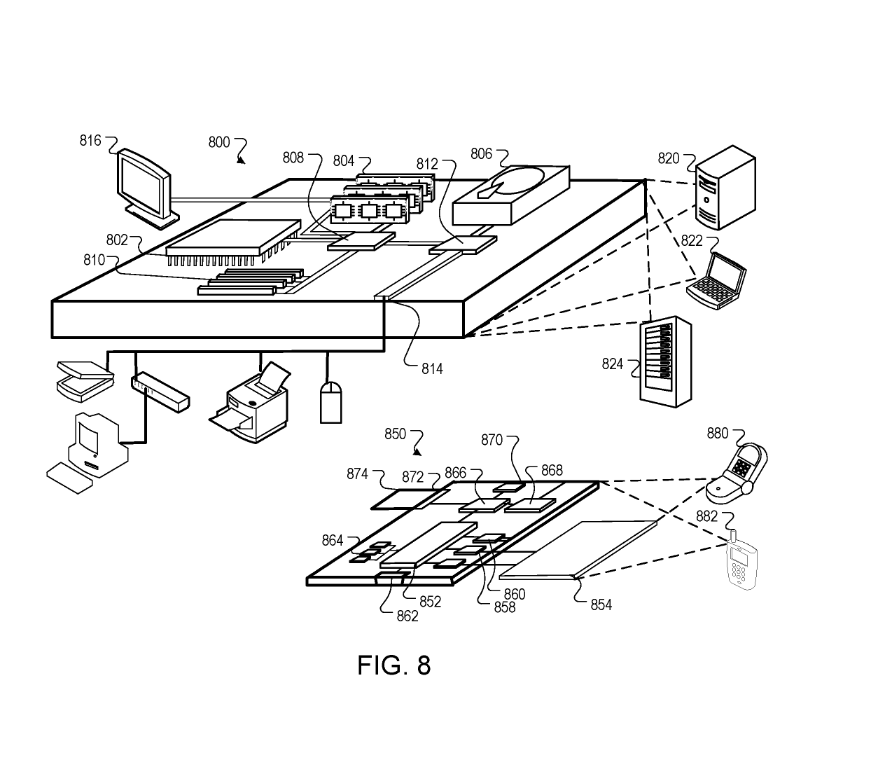

FIG. 8 shows an example of example computing device 800 and example mobile computing device 850, which can be used to implement the techniques described herein. For example, a portion or all of the operations of font monitor 218 (shown in FIG. 2) may be executed by the computing device 800 and/or the mobile computing device 850. Computing device 800 is intended to represent various forms of digital computers, including, e.g., laptops, desktops, workstations, personal digital assistants, servers, blade servers, mainframes, and other appropriate computers. Computing device 850 is intended to represent various forms of mobile devices, including, e.g., personal digital assistants, tablet computing devices, cellular telephones, smartphones, and other similar computing devices. The components shown here, their connections and relationships, and their functions, are meant to be examples only, and are not meant to limit implementations of the techniques described and/or claimed in this document.

Computing device 800 includes processor 802, memory 804, storage device 806, high-speed interface 808 connecting to memory 804 and high-speed expansion ports 810, and low speed interface 812 connecting to low speed bus 814 and storage device 806. Each of components 802, 804, 806, 808, 810, and 812, are interconnected using various busses, and can be mounted on a common motherboard or in other manners as appropriate. Processor 802 can process instructions for execution within computing device 800, including instructions stored in memory 804 or on storage device 806 to display graphical data for a GUI on an external input/output device, including, e.g., display 816 coupled to high speed interface 808. In other implementations, multiple processors and/or multiple busses can be used, as appropriate, along with multiple memories and types of memory. Also, multiple computing devices 800 can be connected, with each device providing portions of the necessary operations (e.g., as a server bank, a group of blade servers, or a multi-processor system).

Memory 804 stores data within computing device 800. In one implementation, memory 804 is a volatile memory unit or units. In another implementation, memory 804 is a non-volatile memory unit or units. Memory 804 also can be another form of computer-readable medium (e.g., a magnetic or optical disk. Memory 804 may be non-transitory.)

Storage device 806 is capable of providing mass storage for computing device 800. In one implementation, storage device 806 can be or contain a computer-readable medium (e.g., a floppy disk device, a hard disk device, an optical disk device, or a tape device, a flash memory or other similar solid state memory device, or an array of devices, such as devices in a storage area network or other configurations.) A computer program product can be tangibly embodied in a data carrier. The computer program product also can contain instructions that, when executed, perform one or more methods (e.g., those described above.) The data carrier is a computer- or machine-readable medium, (e.g., memory 804, storage device 806, memory on processor 802, and the like.)

High-speed controller 808 manages bandwidth-intensive operations for computing device 1100, while low speed controller 812 manages lower bandwidth-intensive operations. Such allocation of functions is an example only. In one implementation, high-speed controller 808 is coupled to memory 804, display 816 (e.g., through a graphics processor or accelerator), and to high-speed expansion ports 810, which can accept various expansion cards (not shown). In the implementation, low-speed controller 812 is coupled to storage device 806 and low-speed expansion port 814. The low-speed expansion port, which can include various communication ports (e.g., USB, Bluetooth®, Ethernet, wireless Ethernet), can be coupled to one or more input/output devices, (e.g., a keyboard, a pointing device, a scanner, or a networking device including a switch or router, e.g., through a network adapter.)

Computing device 800 can be implemented in a number of different forms, as shown in the figure. For example, it can be implemented as standard server 820, or multiple times in a group of such servers. It also can be implemented as part of rack server system 824. In addition or as an alternative, it can be implemented in a personal computer (e.g., laptop computer 822.) In some examples, components from computing device 800 can be combined with other components in a mobile device (not shown), e.g., device 850. Each of such devices can contain one or more of computing device 800, 850, and an entire system can be made up of multiple computing devices 800, 850 communicating with each other.

Computing device 850 includes processor 852, memory 864, an input/output device (e.g., display 854, communication interface 866, and transceiver 868) among other components. Device 850 also can be provided with a storage device, (e.g., a microdrive or other device) to provide additional storage. Each of components 850, 852, 864, 854, 866, and 868, are interconnected using various buses, and several of the components can be mounted on a common motherboard or in other manners as appropriate.

Processor 852 can execute instructions within computing device 850, including instructions stored in memory 864. The processor can be implemented as a chipset of chips that include separate and multiple analog and digital processors. The processor can provide, for example, for coordination of the other components of device 850, e.g., control of user interfaces, applications run by device 850, and wireless communication by device 850.

Processor 852 can communicate with a user through control interface 858 and display interface 856 coupled to display 854. Display 854 can be, for example, a TFT LCD (Thin-Film-Transistor Liquid Crystal Display) or an OLED (Organic Light Emitting Diode) display, or other appropriate display technology. Display interface 856 can comprise appropriate circuitry for driving display 854 to present graphical and other data to a user. Control interface 858 can receive commands from a user and convert them for submission to processor 852. In addition, external interface 862 can communicate with processor 842, so as to enable near area communication of device 850 with other devices. External interface 862 can provide, for example, for wired communication in some implementations, or for wireless communication in other implementations, and multiple interfaces also can be used.

Memory 864 stores data within computing device 850. Memory 864 can be implemented as one or more of a computer-readable medium or media, a volatile memory unit or units, or a non-volatile memory unit or units. Expansion memory 874 also can be provided and connected to device 850 through expansion interface 872, which can include, for example, a SIMM (Single In Line Memory Module) card interface. Such expansion memory 874 can provide extra storage space for device 850, or also can store applications or other data for device 850. Specifically, expansion memory 874 can include instructions to carry out or supplement the processes described above, and can include secure data also. Thus, for example, expansion memory 874 can be provided as a security module for device 850, and can be programmed with instructions that permit secure use of device 850. In addition, secure applications can be provided through the SIMM cards, along with additional data, (e.g., placing identifying data on the SIMM card in a non-hackable manner.)

The memory can include, for example, flash memory and/or NVRAM memory, as discussed below. In one implementation, a computer program product is tangibly embodied in a data carrier. The computer program product contains instructions that, when executed, perform one or more methods, e.g., those described above. The data carrier is a computer- or machine-readable medium (e.g., memory 864, expansion memory 874, and/or memory on processor 852), which can be received, for example, over transceiver 868 or external interface 862.

Device 850 can communicate wirelessly through communication interface 866, which can include digital signal processing circuitry where necessary. Communication interface 866 can provide for communications under various modes or protocols (e.g., GSM voice calls, SMS, EMS, or MMS messaging, CDMA, TDMA, PDC, WCDMA, CDMA2000, or GPRS, among others.) Such communication can occur, for example, through radio-frequency transceiver 868. In addition, short-range communication can occur, e.g., using a Bluetooth®, WiFi, or other such transceiver (not shown). In addition, GPS (Global Positioning System) receiver module 870 can provide additional navigation- and location-related wireless data to device 850, which can be used as appropriate by applications running on device 850. Sensors and modules such as cameras, microphones, compasses, accelerators (for orientation sensing), etc. may be included in the device.

Device 850 also can communicate audibly using audio codec 860, which can receive spoken data from a user and convert it to usable digital data. Audio codec 860 can likewise generate audible sound for a user, (e.g., through a speaker in a handset of device 850.) Such sound can include sound from voice telephone calls, can include recorded sound (e.g., voice messages, music files, and the like) and also can include sound generated by applications operating on device 850.

Computing device 850 can be implemented in a number of different forms, as shown in the figure. For example, it can be implemented as cellular telephone 880. It also can be implemented as part of smartphone 882, a personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor. The programmable processor can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a device for displaying data to the user (e.g., a CRT (cathode ray tube) or LCD (liquid crystal display) monitor), and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a backend component (e.g., as a data server), or that includes a middleware component (e.g., an application server), or that includes a frontend component (e.g., a client computer having a user interface or a Web browser through which a user can interact with an implementation of the systems and techniques described here), or a combination of such back end, middleware, or frontend components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A computing device implemented method comprising:
at a font monitor, receiving data representing one or more activities related to providing one or more fonts to the computing device from a font service provider;
identifying at least one of the one or more activities as being associated with an unauthorized activity; and
initiating action to correct the at least one activity associated with the unauthorized activity.

2. The computing device implemented method of claim 1, wherein the font monitor operates in an independent manner at the computing device.

3. The computing device implemented method of claim 1, wherein the font monitor is included in an application executable by the computing device.

4. The computing device implemented method of claim 1, wherein identifying the least one of the one or more activities as being associated with an unauthorized activity includes the font monitor detecting a font file being copied.

5. The computing device implemented method of claim 1, wherein identifying the least one of the one or more activities as being associated with an unauthorized activity includes the font monitor detecting a font file being moved.

6. The computing device implemented method of claim 1, wherein identifying the least one of the one or more activities as being associated with an unauthorized activity includes the font monitor detecting activity being initiated by an application.

7. The computing device implemented method of claim 1, wherein identifying the least one of the one or more activities as being associated with an unauthorized activity includes the font monitor detecting activity being initiated by a user.

8. The computing device implemented method of claim 1, wherein identifying the least one of the one or more activities as being associated with an unauthorized activity includes the font monitor monitoring an operating system of the computing device.

9. The computing device implemented method of claim 1, wherein identifying the least one of the one or more activities as being associated with an unauthorized activity includes the font monitor detecting the mounting or unmounting of a data storage drive.

10. The computing device implemented method of claim 1, wherein initiating action to correct the at least one activity associated with an unauthorized activity includes deleting copied versions of a font file.

11. The computing device implemented method of claim 1, wherein initiating action to correct the at least one activity associated with an unauthorized activity includes initiating an alert signal.

12. The computing device implemented method of claim 1, wherein initiating action to correct the at least one activity associated with an unauthorized activity includes logging a report of a detected incident.

13. The computing device implemented method of claim 1, wherein initiating action to correct the at least one activity associated with an unauthorized activity includes halting a usage period of one or more fonts.

14. The computing device implemented method of claim 1, wherein the font monitor employs an application programming interface.

15. The computing device implemented method of claim 1, wherein the font monitor is configured to monitor communications between the computing device and a font service provider.

16. A system comprising:
a computing device comprising:
a memory configured to store instructions of a font monitor; and
a processor to execute the instructions of the font monitor to perform operations comprising:
receiving data representing one or more activities related to providing one or more fonts to the computing device from a font service provider;
identifying at least one of the one or more activities as being associated with an unauthorized activity; and
initiating action to correct the at least one activity associated with the unauthorized activity.

17. The system of claim 16, wherein the font monitor operates in an independent manner at the computing device.

18. The system of claim 16, wherein the font monitor is included in an application executable by the computing device.

19. The system of claim 16, wherein identifying the least one of the one or more activities as being associated with an unauthorized activity includes the font monitor detecting a font file being copied.

20. The system of claim 16, wherein identifying the least one of the one or more activities as being associated with an unauthorized activity includes the font monitor detecting a font file being moved.

21. The system of claim 16, wherein identifying the least one of the one or more activities as being associated with an unauthorized activity includes the font monitor detecting activity being initiated by an application.

22. The system of claim 16, wherein identifying the least one of the one or more activities as being associated with an unauthorized activity includes the font monitor detecting activity being initiated by a user.

23. The system of claim 16, wherein identifying the least one of the one or more activities as being associated with an unauthorized activity includes the font monitor monitoring an operating system of the computing device.

24. The system of claim 16, wherein identifying the least one of the one or more activities as being associated with an unauthorized activity includes the font monitor detecting the mounting or unmounting of a data storage drive.

25. The system of claim 16, wherein initiating action to correct the at least one activity associated with an unauthorized activity includes deleting copied versions of a font file.

26. The system of claim 16, wherein initiating action to correct the at least one activity associated with an unauthorized activity includes initiating an alert signal.

27. The system of claim 16, wherein initiating action to correct the at least one activity associated with an unauthorized activity includes logging a report of a detected incident.

28. The system of claim 16, wherein initiating action to correct the at least one activity associated with an unauthorized activity includes halting a usage period of one or more fonts.

29. The system of claim 16, wherein the font monitor employs an application programming interface.

30. The system of claim 16, wherein the font monitor is configured to monitor communications between the computing device and a font service provider.

31. One or more computer readable media storing instructions that are executable by a processing device, and upon such execution cause the processing device to perform operations comprising:
at a font monitor, receiving data representing one or more activities related to providing one or more fonts to the computing device from a font service provider;
identifying at least one of the one or more activities as being associated with an unauthorized activity; and
initiating action to correct the at least one activity associated with the unauthorized activity.

32. The computer readable media of claim 31, wherein the font monitor operates in an independent manner at the computing device.

33. The computer readable media of claim 31, wherein the font monitor is included in an application executable by the computing device.

34. The computer readable media of claim 31, wherein identifying the least one of the one or more activities as being associated with an unauthorized activity includes the font monitor detecting a font file being copied.

35. The computer readable media of claim 31, wherein identifying the least one of the one or more activities as being associated with an unauthorized activity includes the font monitor detecting a font file being moved.

36. The computer readable media of claim 31, wherein identifying the least one of the one or more activities as being associated with an unauthorized activity includes the font monitor detecting activity being initiated by an application.

37. The computer readable media of claim 31, wherein identifying the least one of the one or more activities as being associated with an unauthorized activity includes the font monitor detecting activity being initiated by a user.

38. The computer readable media of claim 31, wherein identifying the least one of the one or more activities as being associated with an unauthorized activity includes the font monitor monitoring an operating system of the computing device.

39. The computer readable media of claim 31, wherein identifying the least one of the one or more activities as being associated with an unauthorized activity includes the font monitor detecting the mounting or unmounting of a data storage drive.

40. The computer readable media of claim 31, wherein initiating action to correct the at least one activity associated with an unauthorized activity includes deleting copied versions of a font file.

41. The computer readable media of claim 31, wherein initiating action to correct the at least one activity associated with an unauthorized activity includes initiating an alert signal.

42. The computer readable media of claim 31, wherein initiating action to correct the at least one activity associated with an unauthorized activity includes logging a report of a detected incident.

43. The computer readable media of claim 31, wherein initiating action to correct the at least one activity associated with an unauthorized activity includes halting a usage period of one or more fonts.

44. The computer readable media of claim 31, wherein the font monitor employs an application programming interface.

45. The computer readable media of claim 31, wherein the font monitor is configured to monitor communications between the computing device and a font service provider.
